(19) United States
(12) Patent Application Publication
(10) Pub. No.: US 2014/0156700 A1
(43) Pub. Date: Jun. 5, 2014

(54) METHOD AND APPARATUS FOR QUERYING AT LEAST ONE VALUE OF AT LEAST ONE PARAMETER OF A MODULE, AND METHOD AND MODULE FOR PROVIDING AT LEAST ONE VALUE OF AT LEAST ONE PARAMETER

(71) Applicant: Andreas Scholz, Unterschleissheim (DE)

(72) Inventor: Andreas Scholz, Unterschleissheim (DE)

(21) Appl. No.: 14/131,394

(22) PCT Filed: Jul. 2, 2012
(86) PCT No.: PCT/EP12/62837

§ 371 Date: Jan. 7, 2014

(30) Foreign Application Priority Data
Jul. 7, 2011 (EP) 11173078.4

(51) Int. Cl. G06F 17/30

(52) U.S. Cl. CPC G06F 17/30011; G06F 17/30424
USPC 707/769

(57) ABSTRACT

The invention relates to a method and an apparatus for querying at least one value of at least one parameter of a module and to a method and a module for providing at least one value of at least one parameter. In this case, a basic scheme is extended by at least one query function to form a scheme, wherein the scheme makes it possible both to configure the module and to query individual values or a plurality of values.

Method and apparatus for querying at least one value of at least one parameter of a module, and method and module for providing at least one value of at least one parameter

The invention relates to a method and an apparatus for querying at least one value of at least one parameter of a module and to a method and a module for providing at least one value of at least one parameter.

Devices which can and must be adapted to local conditions are being used more and more in automation and energy distribution. For this purpose, configuration information is generated and is used to configure the devices.

This configuration information can thus be represented in a flexible and expandable manner with the aid of XML (XML—Extensible Markup Language). The text below illustrates a structured document in XML [5, 6, 7] which provides different parameters for a sensor:

```
<Node>
  <Sensors>
    <Temperature sensor id=”123”>
      <Measuring rate>2</measuring rate>
      <Accuracy>0.1</accuracy>
      ...
    </Temperature sensor>
    <Pressure sensor>
      ...
    </Pressure sensor>
  </Sensors>
  <Actuators>
    ...
  <Actuators>
</Node>
```

In this case, the device comprises a node at which sensors and actuators are registered. The device has a plurality of sensors, inter alia a temperature sensor. This sensor has a configuration parameter—parameter for short—“measuring rate” which indicates how often a measured value is intended to be determined per second. Furthermore, the sensor may provide further parameters, for example “accuracy”, this parameter indicating the accuracy of the sensor. In the above example, two measured values are determined per second with an accuracy of 0.1 degrees.

In addition to configuring the device, it is also necessary to read parameters of the device, for example the measured value of the temperature sensor. For this purpose, use is made of a query language XPATH [1], for example, which queries the device based on the above structure by means of path expressions. In order to access the measuring rate in the above example, the following XPATH expression could be used:

The disadvantage of the use of XPATH is that the device must support both a first method for configuring the parameters and a second method for retrieving the parameters. Use of XPATH is virtually excluded, in particular, for small devices with very limited storage space and very low computing power, such as microcontrollers with a 2 Kbyte memory, 5 Kbyte program code and a computing power of 1 MIPS (MIPS—Million Instructions Per Second).

A further known language for querying data structures is Query-by-Example, see document [4].

Therefore, the object is to provide methods, apparatuses and modules, which make it possible to query configuration parameters in a simple and efficient manner, for devices which are configured with the aid of structured documents, for example XML.

This object is achieved by means of the independent claims. Developments of the invention can be gathered from the dependent claims.

The invention relates to a method for querying at least one value of at least one parameter of a module, wherein the at least one parameter can be described as an element using a basic scheme, and at least one of the parameters can be configured using a value form of the element, having the following steps of:
generating a scheme by supplementing the basic scheme with a query function in such a manner that the element of the at least one parameter, the at least one value of which is intended to be queried, can be marked using the query function;
producing a first structured document on the basis of the scheme in such a manner that the first structured document both has at least that element for the at least one parameter, the at least one value of which is intended to be queried, and assigns the query function to this element;
querying the at least one value of the at least one parameter using the first structured document, wherein the at least one parameter can be communicated to the module on the basis of the query function, and the at least one value of the at least one parameter can then be read.

The method exhibits the advantage that the query and the configuration of the module can be effected as a structured document on the basis of only one scheme since the parameters to be configured and to be queried can be configured and queried by means of the scheme. As a result, there is no need to implement a further parser, such as XPATH, on the module in addition to a parser for structured documents. This saves resources, such as storage space or computing power for the further parser, on the module.

A structured document should be understood as meaning a document in textual or binary form which is produced on the basis of the scheme. Both the textual form and the binary form may be based on an XML description language (XML—Extensible Markup Language) [5, 6, 7]. The binary form preferably follows the BIM [2] or EXI [3] standard.

In a first extension, the query function is provided using a special value form of the value form of the element. This makes it possible to easily signal the query function. Specific numbers and characters can be used as a special value form. Furthermore, the special value form can be implemented by signaling only the element but omitting the value form.

Furthermore, if a content of the special value form is specifically selected for each element, there is no need to consider existing ranges of values of the value forms of other elements used in the first structured document. This enables particularly efficient coding. If, alternatively, a content of the special value form is selected consistently for all elements, the parser for the structured first document can be easily implemented since the parser must react only to a single content in all elements to be queried with respect to the query function.

Furthermore, a third attribute may be assigned to the element in such a manner that the third attribute explicitly indicates the special value form. This makes it possible to dynamically adapt the special value form.

In a second extension, the query function is provided using a first attribute of the element. This makes it possible to easily implement the query function. In addition, the second extension can be used if the range of values of the value form of the element does not allow a special value form or it is possible to code the special value form only with a large amount of effort.

The element of the scheme is preferably supplemented with at least one second attribute in order to specify an embodiment of the query function. This makes it possible to control the embodiment of the query of the parameter using the first document. In particular, the at least one second attribute is used to signal a number of levels in the tree spanned by the elements of the first structured document, for which the value forms are intended to be returned as the value of the parameters. This makes it possible to specifically control the provision of the at least one value in order to keep storage space needed to provide the at least one value low, for example.

A response to the query of the at least one value is advantageously made using a second structured document which is produced on the basis of the scheme and has at least the value form corresponding to the at least one value together with the associated element. This will further simplify a query of the at least one value since the response to the query and the query are achieved with the aid of a structured document on the basis of the scheme.

At least one of the structured documents is preferably produced in textual form, thus providing good legibility by means of the parser.

As an alternative, at least one of the structured documents may be produced either (i) in binary form or (ii) first of all in textual form and then in binary form by means of coding using a text-to-binary coder, wherein the binary form is implemented, in particular, according to either of the BIM and EXI standards. As a result, the query of the at least one value is coded in a very compact manner with the aid of the binary form and can be implemented and executed on the module in a resource-saving manner, that is to say with reduced storage space and reduced computing power. Binary coding according to EXI [3] or BIM [2] makes it possible for a parser of the structured document in binary form to operate directly on the binary data, that is to say without decoding from the binary form to the textual form.

In a preferable extension, at least one of the structured documents and/or the scheme is/are produced according to an XML description language [5, 6, 7]. Use of a standardized description language enables cost-effective implementation since it is possible to resort to existing modules during implementation.

The invention also relates to a method for establishing a scheme for querying at least one value of at least one parameter of a module, wherein the at least one parameter can be described as an element using a basic scheme, and at least one of the parameters can be configured using a value form of the element, wherein the scheme is produced by supplementing the basic scheme with a query function in such a manner that the element of the at least one parameter, the at least one value of which is intended to be queried, can be marked using the query function. As a result, at least one value of the at least one parameter of the module is configured and queried on the basis of a single scheme, which can be implemented with the aid of a single parser for structured documents without having to implement an additional parser, such as XPATH. This enables implementation with a low storage requirement. In addition, the establishing method can be extended according to one of the extensions of the querying method. The advantages are similar to those of the querying method.

Furthermore, the invention relates to an apparatus for querying at least one value of at least one parameter of a module, wherein the at least one parameter can be described as an element using a basic scheme, and at least one of the parameters can be configured using a value form of the element, having the following means:
first means for generating a scheme by supplementing the basic scheme with a query function in such a manner that the element of the at least one parameter, the at least one value of which is intended to be queried, can be marked using the query function;
second means for producing a first structured document on the basis of the scheme in such a manner that the first structured document both has at least that element for the at least one parameter, the at least one value of which is intended to be queried, and assigns the query function to this element;
third means for querying the at least one value of the at least one parameter using the first structured document, wherein the at least one parameter can be communicated to the module on the basis of the query function, and the at least one value of the at least one parameter can then be read.

This apparatus may also be extended using at least one fourth means which is configured in such a manner that said means can be used to carry out at least one of the method steps according to the above statements with respect to the querying method.

The apparatus and its extensions have the same advantages as the respective corresponding steps of the querying method.

The invention moreover relates to a method for providing at least one value of at least one parameter by means of a module, wherein the at least one parameter can be described as an element using a basic scheme, and at least one of the parameters can be configured using a value form of the element, having the following steps of:
receiving a first structured document on the basis of a scheme, wherein the scheme is generated by supplementing the basic scheme with a query function in such a manner that the element of the at least one parameter, the at least one value of which is intended to be queried, can be marked using the query function and the first structured document both has at least that element for the at least one parameter, the at least one value of which is intended to be queried, and assigns the query function to this element;
providing the at least one value of the at least one parameter on the basis of the reception of the first structured document in such a manner that the element and the parameter corresponding to the element are determined on the basis of the query function and the at least one value of the at least one parameter is provided, in particular in a second structured document.

The providing method can be extended in a similar manner to the querying method. The providing method and the respective extensions have the same advantages as the respective steps of the querying method.

Finally, the invention relates to a module for providing at least one value of at least one parameter, wherein the at least one parameter can be described as an element using a basic scheme, and at least one of the parameters can be configured using a value form of the element, having the following units:
a first unit for receiving a first structured document on the basis of a scheme, wherein the scheme is generated by supplementing the basic scheme with a query function in such a manner that the element of the at least one parameter, the at least one value of which is intended to be queried, can be marked using the query function and the first structured document both has at least that element for the at least one parameter, the at least one value of which is intended to be queried, and assigns the query function to this element;
a second unit for providing the at least one value of the at least one parameter on the basis of the reception of the first structured document in such a manner that the element and the parameter corresponding to the element are determined on the basis of the query function and the at least one value of the at least one parameter is provided, in particular in the form of a second structured document.

This module may also be extended using at least one third unit which is configured in such a manner that it can be used to carry out at least one of the method steps according to the above statements with respect to the providing method.

The module and its extensions have the same advantages as the respective corresponding steps of the providing method.

The invention and its developments are explained in more detail below using drawings, in which in detail:

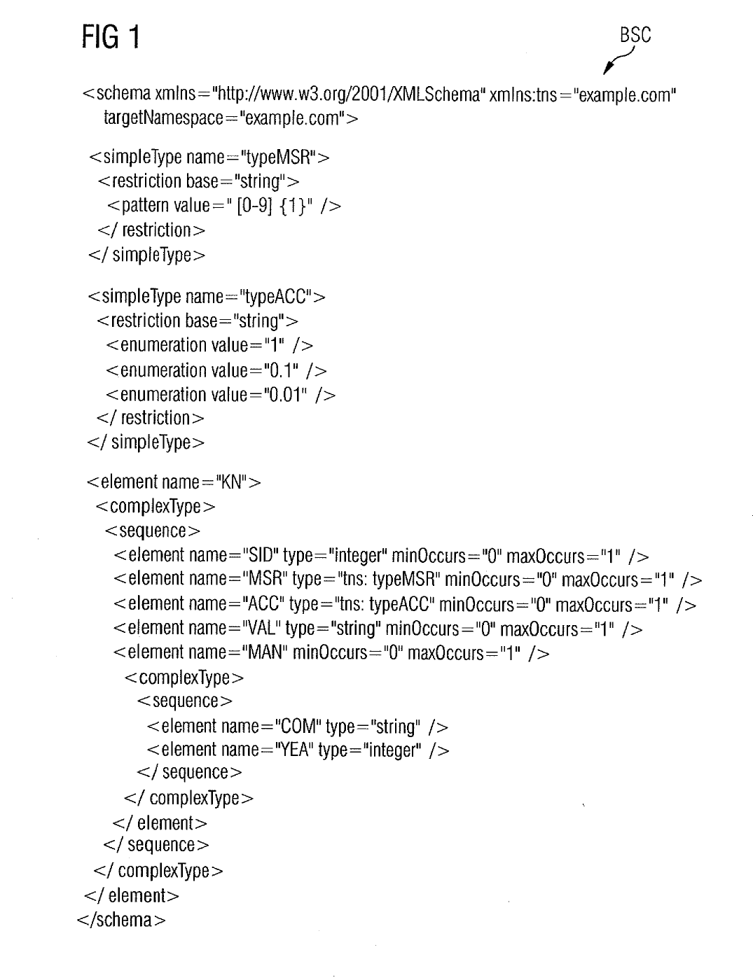

FIG. 1 shows a basic scheme for configuring a module

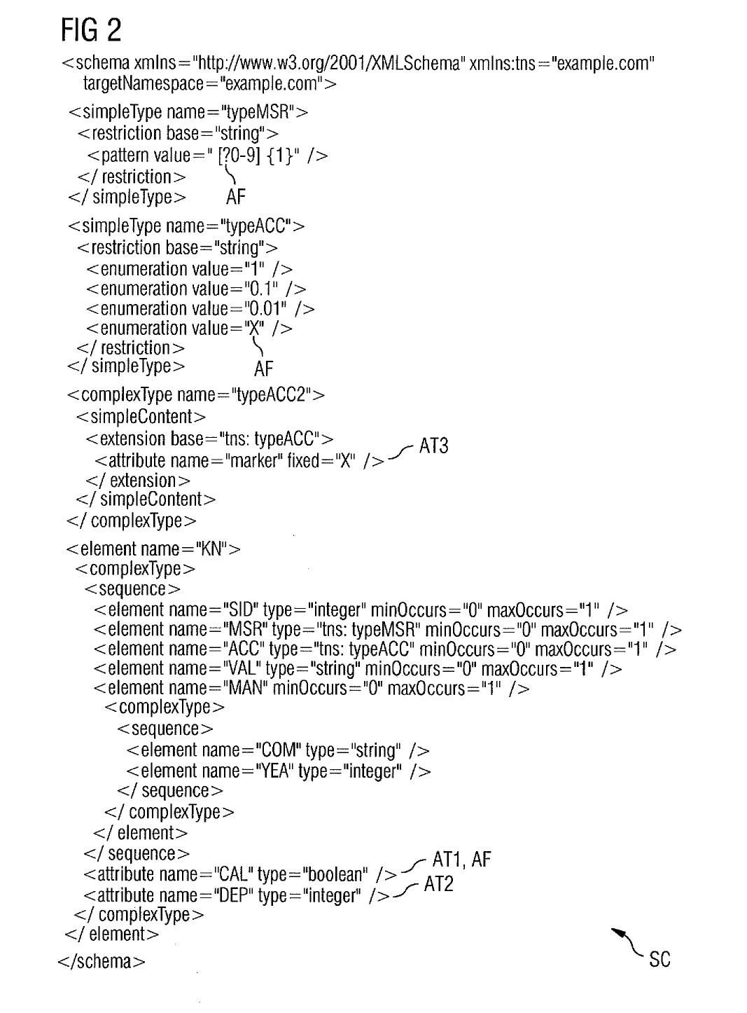

FIG. 2 shows a scheme for configuring and querying at least one value of at least one parameter of the module

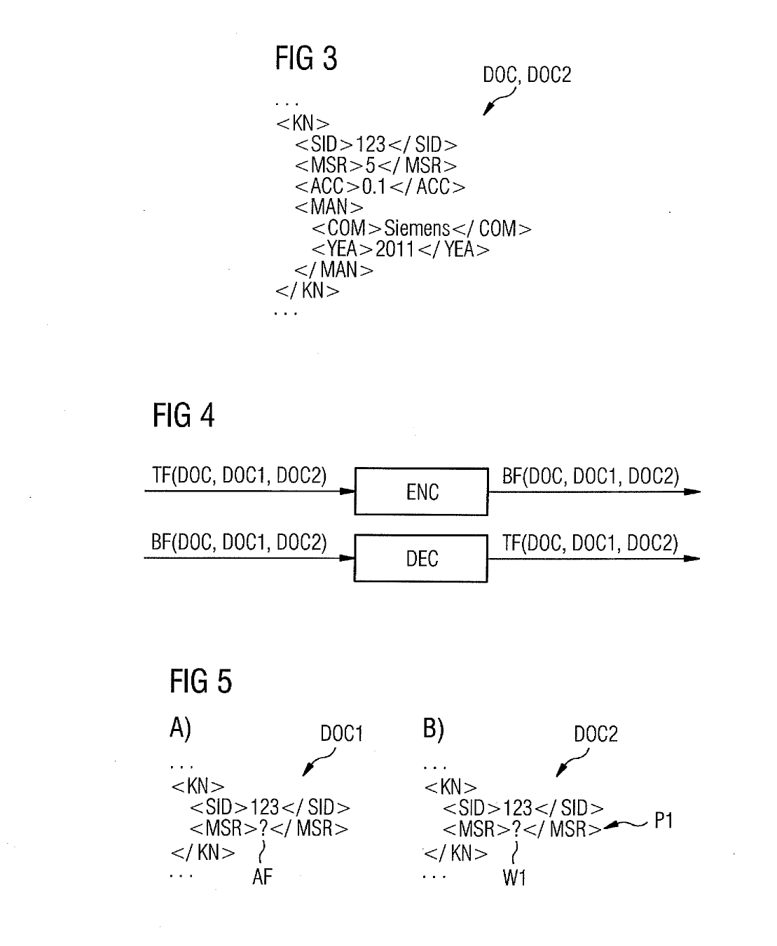

FIG. 3 shows configuration of the module using a structured document

FIG. 4 shows coding of the structured document from a textual form to a binary form and decoding of the structured document from a binary form to a textual form

FIG. 5A/B shows a first example of a query using a first structured document and provision using a second structured document

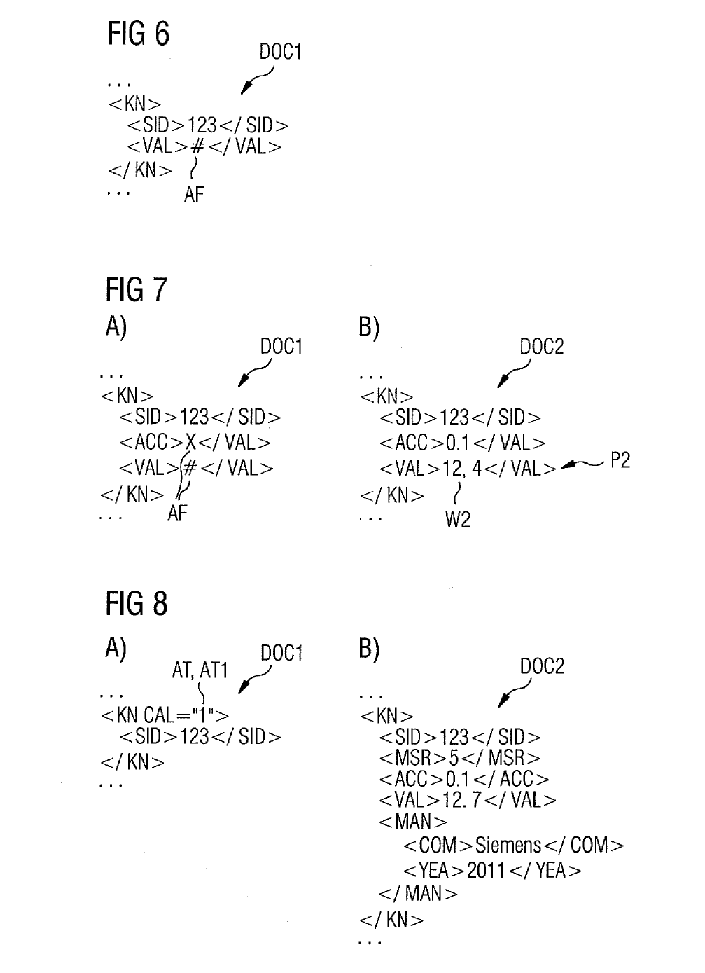

FIG. 6 shows a second example of a query

FIG. 7A/B shows a third example of a query of values of a plurality of parameters and provision of the values

FIG. 8A/B shows a fourth example for querying and providing values of a plurality of parameters

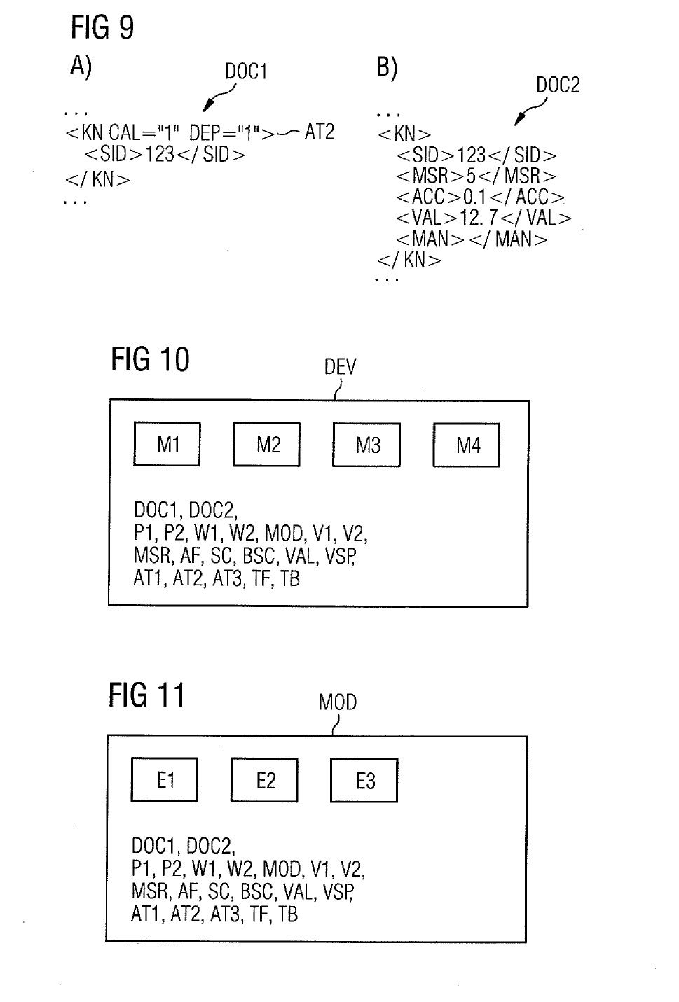

FIG. 9A/B shows a fifth example for querying and providing values of a plurality of parameters using a second attribute for specifying an embodiment of the query

FIG. 10 shows an apparatus for querying at least one value of at least one parameter

FIG. 11 shows a module for providing at least one value of at least one parameter.

Elements with the same function and method of operation are provided with the same reference symbols in the figures.

FIG. 1 shows a basic scheme BSC for configuring a module which is synonymous with the term “device” which is also used. This basic scheme is based on an XML language (XML—Extensible Markup Language). In this case, the individual elements represent the following configuration parameters—also called parameters below:

| Element | |
|---|---|
| name | Parameter |
| KN | Node |
| SID | Sensor identification |
| MSR | Measuring rate (number of measured values per second) |
| ACC | Accuracy (of the measured values) |
| VAL | Measured value |
| MAN | Manufacturer information |
| COM | Manufacturer name |
| YEA | Year of manufacture |

This basic scheme according to XML (Extended Markup Language) [5, 6, 7] has value forms of the elements which represent a value for the parameter corresponding to the element. In this respect, XML defines standard data types such as string or integer. In addition, it is also possible to produce separate new data types, for example typeACC which allows the value forms 1, 0.1 and 0.01 for the element ACC. The element ACC defines how many decimal places are in the value of the measured value parameter, that is to say 0, 1 or two decimal places.

FIG. 2 shows a scheme SC according to XML which has been extended with a query function AF with respect to the scheme from FIG. 1. The meaning of the elements and value forms explained in the basic scheme from FIG. 1 is retained in the scheme from FIG. 2. The query function is used to allocate a marking to the element assigned to the parameter, which marking indicates that the value of this parameter is intended to be queried. On the one hand, the following data types now allow the possibility of defining a further character, wherein the further character represents a special value form which is used to signal the query of the element constructed by the data type:

| Data type | special value form VSP |
|---|---|
| typeMSR | “?” |
| typeACC | “X” |

In addition, the measured value may be implicitly queried using the special value form “#” of the element VAL. This special value form will not occur during a measurement, with the result that, in addition to the explicit indication, like in the above data types, it is also possible to implicitly define the special value form in such a manner that the special value form assumes a value which is not reached by the parameter of the device. In addition, the element and/or the data type may be supplemented with a third attribute which defines the special value form. An example of this is shown by a data type typeACC2 which supplements the existing data type typeACC with the third attribute. This third attribute specifies the value form “X” as the query function.

Instead of different special value forms, a number or character may also represent the special value form, for example “?”. In the case of the special value forms, the quotation marks do not belong to the value form. They are indicated only for better legibility of the description.

In addition, in FIG. 2, the element KN also has a first attribute AT1 as the query function AF, which attribute indicates a query request of the element KN—that is to say the value of the node parameter. The first attribute AT1 with a name CAL can assume the values 0 and 1. The value 1 signals that the value for the element KN is queried.

The subsequent FIGS. 3 to 9 show exemplary embodiments of the invention in the form of part of a structured, for example XML-based, document DOC.

FIG. 3 shows the structured document DOC taking into account the scheme SC which shows the configuration data. In this case, the following values are set for configuring parameters:

| Parameter | Value |
|---|---|
| Sensor identification | 123 |
| Measuring rate | 5 |
| Resolution | 0.1 |
| Manufacturer name | Siemens |
| Year of manufacture | 2011 |

FIG. 3 et seq. each show a textual form TF of the respective structured document. As an alternative, the respective structured document may also be produced in a binary form. On the one hand, this may be effected by directly generating the respective structured document in a binary form. On the other hand, the respective structured document may first of all be produced in its textual form and may then be coded or compressed into a binary form BF using an XML-to-binary coder, for example according to a BIM [2] or EXI [3] standard. The XML-to-binary coder ENC converts the textual form of the structured document DOC into a binary form in order to reduce a data volume. However, the structure and content of the first document are retained or can be reconstructed. FIG. 4 shows this coding by way of example. Decoding is carried out in a similar manner to coding using a decoder DEC, for example a binary-to-XML decoder.

In order to query the current measuring rate in the device, the query function AF is activated in the element MSR using the special value form “?”. A first structured document DOC1 based on the scheme SC can be seen in FIG. 5A and has the query function. In this case, the sensor identification is stated in order to address the sensor in the device if there are a plurality of sensors. The value form of the element MSR is set to “?” according to the special value form. The first structured document DOC1 may also be coded in textual form and binary form. After receiving the first structured document, the module/device discerns that the special value form has been set for the element MSR and the value of the measuring rate parameter is therefore intended to be read and transmitted to a query unit. The value to be read, once entered in a second structured document DOC2 according to the scheme SC, can be transmitted to the query unit, see FIG. 5B. It is also possible to use the first structured document, in textual or binary form, as the second structured document and to replace the special value form with the queried value in this case.

The measured value can be queried in a similar manner to the query of the measuring rate, see FIG. 6. In this case, the character “#” is set in the element VAL as the special value form.

In addition to querying individual values of the parameters, it is also possible to query a plurality of values at once. The measured value and the accuracy are queried together in the query document according to FIG. 7A. For this purpose, the elements SID, ACC and VAL are each signaled with the associated special value forms in the second document. The further procedure is similar to the above description. The second structured document according to FIG. 7B shows the provision of the values of queried parameters.

FIG. 8A shows a further exemplary embodiment in which the query function is effected using the first attribute CAL. In this case, all parameters of the node with the sensor identification “123” are read. The provided values of the queried parameters can be seen in FIG. 8B. FIG. 9A shows a modification of the exemplary embodiment according to FIG. 8A in which, in addition to the query function, an embodiment of the query is effected using a second attribute AT2. This second attribute with a name DEP indicates how many levels, counted from the current level, are intended to be returned by the query in the second structured document. In FIG. 9A, DEP has the value 1, as a result of which only the values of the parameters in the current level are read. The second structured document in FIG. 9B shows the query result. The second structured document generally describes a hierarchical tree defined by the scheme. In this case, the current level of the element KN comprises all elements which directly originate from the element KN. A value of 2 for the second attribute with the name DEP includes all elements in the current level and child elements of the elements in the current level.

Finally, an extension of the above exemplary embodiments involves not specifying the sensor identification, that is to say the element SID, in the query document. As a result, the query will concern all nodes instantiated in the device (not illustrated by a drawing).

FIG. 10 shows an apparatus DEV for querying a value W1, W2 of at least one parameter P1, P2 of a module MOD, having the following means M1, M2, M3:
first means M1 for generating a scheme SC which references the configurable parameters P1, P2 of the module as elements MSR, VAL and the value W1, W2 associated with the respective parameter P1, P2 as the value form V1, V2 and marks the element MSR of the at least one parameter P1, the value W1 of which is intended to be queried, using a query function AF;
second means M2 for producing a first structured document DOC1 on the basis of the scheme SC in such a manner that said document both has at least that element MSR for the parameter P1, which is intended to be queried, and assigns the query function AF to this element MSR;
third means M3 for querying the value W1 of the at least one parameter P1 using the first structured document DOC1, wherein the at least one parameter P1 can be communicated to the module MOD on the basis of the query function AF, and the value W1 of the at least one parameter P1 can be read.

In addition, the apparatus DEV has at least one fourth means M4 which is configured in such a manner that said means can be used to carry out at least one of the extensions of the method.

FIG. 11 also shows the module MOD for providing a value W1 of at least one parameter P1, having the following units E1, E2:
a first unit E1 for receiving a first structured document DOC1 on the basis of a scheme SC, wherein the first structured document DOC1 both has at least that element MSR for the parameter P1, which is intended to be queried, and assigns the query function AF to this element MSR, the scheme SC describes the parameters P1 of the module MOD and defines a query function AF in such a manner that the query function AF can be used to mark the element MSR which is assigned to the at least one parameter P1 and the value of which is intended to be queried;
a second unit E2 for providing the at least one value W1 of the at least one parameter P1 on the basis of the reception of the first structured document DOC1 in such a manner that the element MSR and the parameter P1 corresponding to the element MSR are determined on the basis of the query function AF and the value W1 of the at least one parameter P1 is provided, in particular in the form of a second structured document DOC2.

The module MOD may also have at least one third unit E3 which is configured in such a manner that it can be used to implement at least extensions during provision.

The means M1, M2, M3, M4 of the apparatus and the units E1, E2 and E3 of the module may be designed using hardware, software or a combination of hardware and software. For example, a processor carries out the steps of the method which are stored as program code in a memory affiliated with the processor. The processor also has an input and output interface for interchanging the first and second structured documents, possibly after their text-to-binary coding, for configuring the module, querying parameter values of the module and receiving queried parameter values from the module. In addition, intermediate results of the individual processing steps may be additionally stored in the memory. Furthermore, the means M1, M2, M3, M4 and the units E1, E2, E3 of the module may also be implemented by means of hard wiring of electronic components to a memory module.

The invention and its development were explained using a plurality of examples. However, the invention is not only restricted to the examples. In addition, the exemplary embodiments may also be combined.

### Literature

[1] XML Path Language (XPath), Version 1.0, W3C Recommendation, Nov. 16, 1999, http://www.w3.org/TR/xpath/; W3C

[2] Information technology—MPEG systems technologies—Part 1: Binary MPEG format for XML, ISO/IEC FDIS 23001-1:2005 (E), ISO/IEC JTC 1/SC 29/WG 11, w7597, Nov. 4, 2005

[3] J. Schneider and T. Kamiya. Efficient XML Interchange (EXI) Format 1.0. W3C Working Draft, Sep. 19, 2008

[4] Query-By-Example, http://en.wikipedia.org/wiki/Query_by_Example, as at: Jul. 6, 2011

[5] David C. Fallside (IBM); XML Schema Part 0: Primer;

http://www.w3.org/TR/2001/REC-xmlschema-0-20010502/; www.w3.org; W3C

[6] Henry S. Thompson et al.; XML Schema Part 1: Structures;

http://www.w3.org/TR/2001/REC-xmlschema-1-20010502/; www.w3.org; W3C

[7] Paul V. Biron; XML Schema Part 2: Datatypes; http://www.w3.org/TR/2001/REC-xmlschema-2-20010502/; www.w3.org; W3C

1. A method for querying at least one value (W1, W2) of at least one parameter (P1, P2) of a module (MOD), wherein the at least one parameter (P1, P2) can be described as an element (MSR, VAL) using a basic scheme (BSC), and at least one of the parameters (P1, P2) can be configured using a value form (V1, V2) of the element (MSR, VAL), having the following steps of:
generating a scheme (SC) by supplementing the basic scheme (BSC) with a query function (AF) in such a manner that the element (MSR) of the at least one parameter (P1), the at least one value (W1) of which is intended to be queried, can be marked using the query function (AF);
producing a first structured document (DOC1) on the basis of the scheme (SC) in such a manner that the first structured document (DOC1) both has at least that element (MSR) for the at least one parameter (P1), the at least one value (W1) of which is intended to be queried, and assigns the query function (AF) to this element (MSR);
querying the at least one value (W1) of the at least one parameter (P1) using the first structured document (DOC1), wherein the at least one parameter (P1) can be communicated to the module (MOD) on the basis of the query function (AF), and the at least one value (W1) of the at least one parameter (P1) can then be read.

2. The method as claimed in claim 1,
in which the following step is carried out:
the query function (AF) is provided using a special value form (VSP) of the value form (V1) of the element (MSR).

3. The method as claimed in claim 2,
in which a content of the special value form (VSP) is selected either specifically for each element (MSR, ACC) or consistently for all elements (MSR, ACC).

4. The method as claimed in either of claims 2 and 3,
in which a third attribute (AT3) is assigned to the element (MSR) in such a manner that the third attribute (AT3) explicitly indicates the special value form (VSP).

5. The method as claimed in claim 1,
in which the following step is carried out:
the query function (AF) is provided using a first attribute (AT1) of the element (MSR).

6. The method as claimed in one of the preceding claims,
in which the element (MSR) of the scheme (SC) is supplemented with at least one second attribute (AT2) in order to specify an embodiment of the query function (AF).

7. The method as claimed in claim 6,
in which the at least one second attribute (AT2) is used to signal a number of levels in the tree spanned by the elements (SID, MSR, ACC, VAL, MAN, COM, YEA, KN) of the first structured document (DOC1), for which the value forms are intended to be returned as the value of the parameters.

8. The method as claimed in one of the preceding claims,
in which a response to the query of the value (W1) is made using a second structured document (DOC2) which is produced on the basis of the scheme (SC) and has at least the value form (V1) corresponding to the at least one value (W1) together with the associated element (MSR).

9. The method as claimed in one of claims 1 to 8,
in which at least one of the structured documents (DOC1, DOC2) is produced in textual form (TF).

10. The method as claimed in one of claims 1 to 8,
in which at least one of the structured documents (DOC1, DOC2) is produced either (i) in binary form (BF) or (ii) first of all in textual form (TF) and then in binary form (BF) by means of coding using a text-to-binary coder (COD), wherein the binary form (BF) is implemented, in particular, according to either of the BIM and EXI standards.

11. The method as claimed in one of the preceding claims,
in which at least one of the structured documents (DOC1, DOC2) and/or the scheme (SC) is/are produced according to the XML description language.

12. A method for establishing a scheme (SC) for querying at least one value (W1, W2) of at least one parameter (P1, P2) of a module (MOD), wherein the at least one parameter (P1, P2) can be described as an element (MSR, VAL) using a basic scheme (BSC), and at least one of the parameters (P1, P2) can be configured using a value form (V1, V2) of the element (MSR, VAL),
characterized in that
the scheme (SC) is produced by supplementing the basic scheme (BSC) with a query function (AF) in such a manner that the element (MSR) of the at least one parameter (P1), the at least one value (W1) of which is intended to be queried, can be marked using the query function (AF).

13. The method as claimed in claim 12,
in which at least one of the method steps as claimed in one of claims 2 to 6 is carried out when establishing the scheme (SC).

14. An apparatus (DEV) for querying at least one value (W1, W2) of at least one parameter (P1, P2) of a module (MOD), wherein the at least one parameter (P1, P2) can be described as an element (MSR, VAL) using a basic scheme (BSC), and at least one of the parameters (P1, P2) can be configured using a value form (V1, V2) of the element (MSR, VAL),
having the following means (M1, M2, M3):
first means (M1) for generating a scheme (SC) by supplementing the basic scheme (BSC) with a query function (AF) in such a manner that the element (MSR) of the at least one parameter (P1), the at least one value (W1) of which is intended to be queried, can be marked using the query function (AF);
second means (M2) for producing a first structured document (DOC1) on the basis of the scheme (SC) in such a manner that the first structured document (DOC1) both has at least that element (MSR) for the at least one parameter (P1), the at least one value (W1) of which is intended to be queried, and assigns the query function (AF) to this element (MSR);
third means (M3) for querying the at least one value (W1) of the at least one parameter (P1) using the first structured document (DOC1), wherein the at least one parameter (P1) can be communicated to the module (MOD) on the basis of the query function (AF), and the at least one value (W1) of the at least one parameter (P1) can then be read.

15. The apparatus (DEV) as claimed in claim 14,
in which the apparatus (DEV) has at least one fourth means (M4) which is configured in such a manner that said means can be used to carry out at least one of the method steps as claimed in one of claims 2 to 11.

16. A method for providing at least one value (W1) of at least one parameter (P1) by means of a module (MOD), wherein the at least one parameter (P1, P2) can be described as an element (MSR, VAL) using a basic scheme (BSC), and at least one of the parameters (P1, P2) can be configured using a value form (V1, V2) of the element (MSR, VAL), having the following steps of:
receiving a first structured document (DOC1) on the basis of a scheme (SC), wherein the scheme (SC) is generated by supplementing the basic scheme (BSC) with a query function (AF) in such a manner that the element (MSR) of the at least one parameter (P1), the at least one value (W1) of which is intended to be queried, can be marked using the query function (AF) and the first structured document (DOC1) both has at least that element (MSR) for the at least one parameter (P1), the at least one value (W1) of which is intended to be queried, and assigns the query function (AF) to this element (MSR);
providing the at least one value (W1) of the at least one parameter (P1) on the basis of the reception of the first structured document (DOC1) in such a manner that the element (MSR) and the parameter (P1) corresponding to the element (MSR) are determined on the basis of the query function (AF) and the at least one value (W1) of the at least one parameter (P1) is provided, in particular in the form of a second structured document (DOC2).

17. The method as claimed in claim 16,
in which the query function (AF) is determined using a special value form (VSP) of the value form (V1) of the element (MSR).

18. The method as claimed in claim 17,
in which it is determined whether a content of the special value form (VSP) is selected either specifically for each element (MSR) or consistently for all elements (MSR).

19. The method as claimed in either of claims 17 and 18,
in which the special value form (VSP) is determined using a third attribute (AT3) assigned to the element (MSR).

20. The method as claimed in claim 16,
in which the query function (AF) is determined using a first attribute (AT1) of the element (MSR).

21. The method as claimed in one of claims 16 to 18,
in which it is determined whether the element (MSR) of the scheme (SC) is supplemented with at least one second attribute (AT2) in order to specify an embodiment of the query function (AF).

22. The method as claimed in claim 21,
in which it is determined whether the at least one second attribute (AT2) is used to signal a number of levels in the tree spanned by the elements (SID, MSR, ACC, VAL, MAN, COM, YEA, KN) of the first structured document (DOC1), for which the value forms are intended to be returned as the value of the parameters.

23. The method as claimed in one of claims 16 to 22,
in which a response to the query of the at least one value (W1) is made using a second structured document (DOC2) which is produced on the basis of the scheme (SC) and has at least the value form (V1) corresponding to the at least one value (W1) together with the associated element (MSR).

24. The method as claimed in one of claims 16 to 23,
in which at least the second structured document (DOC2) is produced in textual form (TF).

25. The method as claimed in one of claims 16 to 23,
in which at least one of the structured documents (DOC1, DOC2) is produced either (i) in binary form (BF) or (ii) first of all in textual form (TF) and then in binary form (BF) by means of coding using a text-to-binary coder (COD), wherein the binary form (BF) is implemented, in particular, according to either of the BIM and EXI standards.

26. The method as claimed in one of claims 16 to 25,
in which at least one of the structured documents (DOC1, DOC2) and/or the scheme (SC) is/are produced according to the XML description language.

27. A module (MOD) for providing at least one value (W1) of at least one parameter (P1), wherein the at least one parameter (P1, P2) can be described as an element (MSR, VAL) using a basic scheme (BSC), and
at least one of the parameters (P1, P2) can be configured using a value form (V1, V2) of the element (MSR, VAL), having the following units (E1, E2):
a first unit (E1) for receiving a first structured document (DOC1) on the basis of a scheme (SC), wherein the scheme (SC) is generated by supplementing the basic scheme (BSC) with a query function (AF) in such a manner that the element (MSR) of the at least one parameter (P1), the at least one value (W1) of which is intended to be queried, can be marked using the query function (AF) and the first structured document (DOC1) both has at least that element (MSR) for the at least one parameter (P1), the at least one value (W1) of which is intended to be queried, and assigns the query function (AF) to this element (MSR);
a second unit (E2) for providing the at least one value (W1) of the at least one parameter (P1) on the basis of the reception of the first structured document (DOC1) in such a manner that the element (MSR) and the parameter (P1) corresponding to the element (MSR) are determined on the basis of the query function (AF) and the at least one value (W1) of the at least one parameter (P1) is provided, in particular in the form of a second structured document (DOC2).

28. The module (MOD) as claimed in claim 27,
in which the module (MOD) has at least one third unit (E3) which is configured in such a manner that it can be used to carry out at least one of the method steps in at least one of claims 16 to 26.
